(19) United States
(12) Patent Application Publication
(10) Pub. No.: US 2025/0173141 A1
(43) Pub. Date: May 29, 2025

(54) ONLINE UPGRADING METHOD AND APPARATUS FOR SOLID STATE DISK, AND ELECTRONIC DEVICE AND STORAGE MEDIUM

(71) Applicant: SUZHOU METABRAIN INTELLIGENT TECHNOLOGY CO., LTD., Suzhou, Jiangsu (CN)

(72) Inventors: Zuogang YIN, Suzhou, Jiangsu (CN); Ji ZHONG, Suzhou, Jiangsu (CN); Wenzheng QIN, Suzhou, Jiangsu (CN); Jianing CUI, Suzhou, Jiangsu (CN)

(21) Appl. No.: 18/869,581

(22) PCT Filed: Sep. 27, 2023
(86) PCT No.: PCT/CN2023/122274

§ 371 Date: Nov. 26, 2024

(30) Foreign Application Priority Data
Jan. 9, 2023 (CN) 202310029809.6

(51) Int. Cl. G06F 8/654; G06F 13/16; G06F 13/42

(52) U.S. Cl. CPC G06F 8/654; G06F 13/1642; G06F 13/4282

(57) ABSTRACT

Provided is an online upgrading method for a solid state disk, including setting an interaction mode of a serial communication unit as a pause mode in response to receiving a firmware upgrade instruction sent from the host; triggering a CPU processing unit to perform power-down processing, and controlling an internal process interaction unit, the storage unit, a memory processing unit and a control peripheral unit to switch to a standby state; triggering a system reset operation for the solid state disk on the basis of the standby state, and performing firmware upgrade on the solid state disk according to the firmware upgrade instruction; in response to the firmware upgrade being completed, performing initialization processing on the CPU processing unit, the internal process interaction unit, the storage unit, the memory processing unit and the control peripheral unit, and canceling the pause mode of the serial communication unit.

### CROSS-REFERENCE TO RELATED APPLICATION

The present application claims priority to Chinese patent application No. 202310029809.6, entitled “ONLINE UPGRADING METHOD AND APPARATUS FOR SOLID STATE DISK, AND ELECTRONIC DEVICE AND STORAGE MEDIUM”, filed on Jan. 9, 2023 before the China National Intellectual Property Administration, which is incorporated herein in its entirety by reference.

### TECHNICAL FIELD

The present disclosure relates to the field of storage technology, in particular to an online upgrading method for a solid state disk, an online upgrading apparatus for a solid state disk, an electronic device, and a non-transitory readable storage medium.

### BACKGROUND

With the continuous development of computer technology and the explosive growth of various types of information, disks capable of storing a large amount of data have gradually become an indispensable part of people's lives. SSD (Solid State Disk or Solid State Drive) is currently the mainstream disk. Compared with a traditional disk, SSD adopts flash memory as a storage medium, thus it can read and write faster, and SSD has better shock resistance and impact resistance because it does not include any mechanical parts. Moreover, the SSD has the advantages of lower power consumption, less noise, and lighter weight, which makes the SSD more popular.

SSDs are usually connected with external devices capable of communicating, such as a host. Therefore, during the process of service interaction, the host requires the SSD to upgrade firmware from time to time, which involves a switching between an old version of firmware and a new version of firmware. In order to ensure the online upgrading between the host and the SSD without interrupting service, a currently more mainstream method is to use transitional firmware to complete the firmware upgrade, and this upgrade method leads to a higher difficulty and complexity in implementation, thus reducing the reliability of the upgrade.

### SUMMARY

The present disclosure is to provide an online upgrading method for a solid state disk, an online upgrading apparatus for a solid state disk, an electronic device, and a non-transitory readable storage medium.

An embodiment of the present disclosure provides an online upgrading method for a solid state disk, the solid state disk at least includes an internal process interaction unit, as well as a CPU processing unit, a serial communication unit, a storage unit, a memory processing unit and a control peripheral unit that are respectively in communication connection with the internal process interaction unit, wherein the solid state disk is in communication connection with a host via the serial communication unit, the method including:
setting an interaction mode of the serial communication unit as a pause mode in response to receiving a firmware upgrade instruction sent from the host;
triggering the CPU processing unit to perform power-down processing, and controlling the internal process interaction unit, the storage unit, the memory processing unit and the control peripheral unit to switch to a standby state;
triggering a system reset operation for the solid state disk on the basis of the standby state, and performing firmware upgrade on the solid state disk according to the firmware upgrade instruction; and
in response to the firmware upgrade being completed, performing initialization processing on the CPU processing unit, the internal process interaction unit, the storage unit, the memory processing unit and the control peripheral unit respectively, and canceling the pause mode of the serial communication unit.

In some embodiments of the present disclosure, the setting an interaction mode of the serial communication unit as a pause mode in response to receiving a firmware upgrade instruction sent from the host includes:
in response to receiving the firmware upgrade instruction sent from the host, switching the interaction mode of the serial communication unit from a normal mode to the pause mode according to a preset mode switching instruction.

In some embodiments of the present disclosure, before setting the interaction mode of the serial communication unit as the pause mode, the method further includes:
storing valid data of the internal process interaction unit, valid data of the CPU processing unit, valid data of the serial communication unit, valid data of the memory processing unit and valid data of the control peripheral unit in the storage unit respectively.

In some embodiments of the present disclosure, the triggering the CPU processing unit to perform power-down processing includes:
triggering the CPU processing unit to perform power-down processing and controlling the serial communication unit to pause information interaction with the host.

In some embodiments of the present disclosure, the internal process interaction unit includes an internal information interaction network that is used by various hardware units inside the solid state disk to perform information interaction, the triggering the CPU processing unit to perform power-down processing and controlling the serial communication unit to pause information interaction with the host includes:
triggering the CPU processing unit to perform power-down processing, and controlling the serial communication unit to pause information interaction with the host while clearing interaction information in the internal information interaction network.

In some embodiments of the present disclosure, before clearing interaction information in the internal information interaction network, the method further includes:
storing the interaction information in the internal information interaction network to the storage unit.

In some embodiments of the present disclosure, after setting the interaction mode of the serial communication unit as the pause mode, and before triggering the CPU processing unit to perform power-down processing, the method further includes:
controlling a timer in the CPU processing unit to be activated, in response to having not detected within a preset detection duration that processing of the firmware upgrade instruction is completed, determining that an upgrade exception exists in the solid state disk, switching the interaction mode of the serial communication unit from the pause mode to a normal mode, and canceling the firmware upgrade on the solid state disk.

In some embodiments of the present disclosure, the method further includes:
in response to having detected within a preset detection duration that the processing of the firmware upgrade instruction is completed, triggering the CPU processing unit to perform power-down processing.

In some embodiments of the present disclosure, after the triggering the CPU processing unit to perform power-down processing, the method further includes:
controlling the timer in the CPU processing unit to be shut down, and switching the CPU processing unit to the standby state.

In some embodiments of the present disclosure, the internal process interaction unit includes an internal information interaction network, and the controlling the internal process interaction unit, the storage unit, the memory processing unit and the control peripheral unit to switch to the standby state includes:
activating a disabling operation for the storage unit, the memory processing unit and the control peripheral unit, and switching the internal process interaction unit to the standby state, and pausing the information interaction of the internal information interaction network.

In some embodiments of the present disclosure, after the switching the interaction mode of the serial communication unit from the pause mode to the normal mode, the method includes:
sending upgrade exception information about the solid state disk to the host, and stopping receiving a next firmware upgrade instruction sent from the host.

In some embodiments of the present disclosure, the upgrade exception of the solid state disk includes that the solid state disk is in a read-only operating mode, or that a temperature of the solid state disk is greater than or equal to a preset temperature threshold.

In some embodiments of the present disclosure, message cache queues of various hardware units in the solid state disk are stored in the internal process interaction unit, and the performing initialization processing on the CPU processing unit, the internal process interaction unit, the storage unit, the memory processing unit and the control peripheral unit respectively includes:
performing initialization processing on a message cache queue of the CPU processing unit, a message cache queue of the internal process interaction unit, a message cache queue of the storage unit, a message cache queue of the memory processing unit and a message cache queue of the control peripheral unit respectively.

In some embodiments of the present disclosure, each of the message cache queues at least includes a starting queue recording variable Head and an ending queue recording variable Tail, and the performing initialization processing on the message cache queue of the CPU processing unit, the message cache queue of the internal process interaction unit, the message cache queue of the storage unit, the message cache queue of the memory processing unit and the message cache queue of the control peripheral unit respectively includes:
performing initialization processing on the starting queue recording variable Head and the ending queue recording variable Tail of each of the message cache queues.

In some embodiments of the present disclosure, the canceling the pause mode of the serial communication unit includes:
switching the interaction mode of the serial communication unit from the pause mode to a normal mode.

In some embodiments of the present disclosure, the firmware upgrade instruction contains firmware version information, and the performing firmware upgrade on the solid state disk according to the firmware upgrade instruction includes:
performing firmware upgrade on the solid state disk using the firmware version information.

In some embodiments of the present disclosure, after canceling the pause mode of the serial communication unit, the method further includes:
returning a firmware upgrade result to the host.

An embodiment of the present disclosure further provides an online upgrading apparatus for a solid state disk, the solid state disk at least includes an internal process interaction unit, as well as a CPU processing unit, a serial communication unit, a storage unit, a memory processing unit and a control peripheral unit that are respectively in communication connection with the internal process interaction unit, wherein the solid state disk is in communication connection with a host via the serial communication unit, the apparatus including:
a firmware upgrade instruction reception module, configured for setting an interaction mode of the serial communication unit as a pause mode in response to receiving a firmware upgrade instruction sent from the host;
a power-down processing triggering module, configured for triggering the CPU processing unit to perform power-down processing, and controlling the internal process interaction unit, the storage unit, the memory processing unit and the control peripheral unit to switch to a standby state;
a system reset module, configured for triggering a system reset operation for the solid state disk on the basis of the standby state, and performing firmware upgrade on the solid state disk according to the firmware upgrade instruction; and
an initialization processing module, configured for, in response to the firmware upgrade being completed, performing initialization processing on the CPU processing unit, the internal process interaction unit, the storage unit, the memory processing unit and the control peripheral unit respectively, and canceling the pause mode of the serial communication unit.

In some embodiments of the present disclosure, the firmware upgrade instruction reception module is configured for:
in response to receiving the firmware upgrade instruction sent from the host, switching the interaction mode of the serial communication unit from a normal mode to the pause mode according to a preset mode switching instruction.

In some embodiments of the present disclosure, the apparatus further includes:
a valid data storage module configured for storing valid data of the internal process interaction unit, valid data of the CPU processing unit, valid data of the serial communication unit, valid data of the memory processing unit and valid data of the control peripheral unit in the storage unit respectively.

In some embodiments of the present disclosure, the power-down processing triggering module is configured for:
triggering the CPU processing unit to perform power-down processing, and controlling the serial communication unit to pause information interaction with the host.

In some embodiments of the present disclosure, the internal process interaction unit includes an internal information interaction network that is used by hardware units inside the solid state disk to perform information interaction. The power-down processing triggering module is configured for:
triggering the CPU processing unit to perform power-down processing, and controlling the serial communication unit to pause information interaction with the host while clearing interaction information in the internal information interaction network.

In some embodiments of the present disclosure, the apparatus further includes:
an interaction information storage module configured for storing the interaction information in the internal information interaction network to the storage unit.

In some embodiments of the present disclosure, the apparatus further includes:
a timer controlling and activating module, configured for controlling a timer in the CPU processing unit to be activated, and if it is not detected within a preset detection duration that processing of the firmware upgrade instruction is completed, determining that an upgrade exception exits in the solid state disk, switching the interaction mode of the serial communication unit from the pause mode to a normal mode, and canceling the firmware upgrade on the solid state disk.

In some embodiments of the present disclosure, the apparatus further includes:
a power-down processing triggering submodule configured for triggering the CPU processing unit to perform power-down processing if it is detected within a preset detection duration that the processing of the firmware upgrade instruction is completed.

In some embodiments of the present disclosure, the apparatus further includes:
a timer control shutdown module configured for controlling the timer in the CPU processing unit to be shut down and switching the CPU processing unit to the standby state.

In some embodiments of the present disclosure, the internal process interaction unit includes an internal information interaction network, and the power-down processing triggering module is used for:
activating a disabling operation for the storage unit, the memory processing unit and the control peripheral unit, switching the internal process interaction unit to the standby state, and pausing the information interaction of the internal information interaction network.

In some embodiments of the present disclosure, the apparatus includes:
an upgrade exception information transmission module configured for transmitting upgrade exception information about the solid state disk to the host, and stopping receiving a next firmware upgrade instruction sent from the host.

In some embodiments of the present disclosure, the upgrade exception of the solid state disk includes that the solid state disk is in a read-only operating mode, or that a temperature of the solid state disk is greater than or equal to a preset temperature threshold.

In some embodiments of the present disclosure, message cache queues of hardware units in the solid state disk are stored in the internal process interaction unit, and the initialization processing module includes:
a message cache queue initialization module configured for performing initialization processing on a message cache queue of the CPU processing unit, a message cache queue of the internal process interaction unit, a message cache queue of the storage unit, a message cache queue of the memory processing unit and a message cache queue of the control peripheral unit respectively.

In some embodiments of the present disclosure, the message cache queue at least includes a starting queue recording variable Head and an ending queue recording variable Tail, and the message cache queue initialization module is configured for:
performing initialization processing on the starting queue recording variable Head and the ending queue recording variable Tail of each message cache queue.

In some embodiments of the present disclosure, the initialization processing module includes:
an interaction mode switching module configured for switching the interaction mode of the serial communication unit from the pause mode to a normal mode.

In some embodiments of the present disclosure, the system reset module includes:
a firmware upgrade module configured for performing firmware upgrade on the solid state disk using the firmware version information.

In some embodiments of the present disclosure, the apparatus further includes:
a firmware upgrade result returning module configured for returning a firmware upgrade result to the host.

An embodiment of the present disclosure further provides an electronic device, comprising a processor, a communication interface, a memory, and a communication bus, wherein the processor, the communication interface, and the memory communicate with each other via the communication bus:
the memory is configured for storing a computer program; and
the processor is configured for executing the program stored in the memory to implement the online upgrading method for the solid state disk described above.

An embodiment of the present disclosure further provides a non-transistory readable storage medium storing instructions that, when executed by one or more processors, cause the one or more processors to perform the online upgrading method for the solid state disk described above.

### BRIEF DESCRIPTION OF THE DRAWINGS

FIG. 1 is a schematic diagram illustrating an internal structure of a solid state disk provided in an embodiment of the present disclosure;

FIG. 2 is a flow chart of an online upgrading method for a solid state disk provided by an embodiment of the present disclosure;

FIG. 3 is a structural block diagram of an online upgrading apparatus for a solid state disk provided in an embodiment of the present disclosure;

FIG. 4 is a schematic diagram of a non-transitory readable storage medium provided in an embodiment of the present disclosure; and

FIG. 5 is a block diagram of an electronic device provided in an embodiment of the present disclosure.

### DETAILED DESCRIPTION OF THE EMBODIMENTS

To make the objects, features, and advantages of the present disclosure clearer and easier to be understood, the present disclosure will be illustrated in details in conjunction with the accompanying drawings and specific embodiments.

In order to enable those skilled in the art to better understand the technical solutions in the embodiments of the present disclosure, some of the technical features involved in the embodiments of the present disclosure are explained and described below.

SSD (solid state disk or solid state drive) is the current mainstream hard disk, which has advantages described below compared with a traditional hard disk.

Fast read and write speed: by using flash memory as the storage medium, the read speed is faster compared to a mechanical hard disk.

Shock resistance and impact resistance: traditional hard disks are magnetic hard disks with data stored in magnetic disk sectors, while SSDs are made from flash memory chips, that is, the SSDs do not have mechanical parts; accordingly, the normal use thereof is not affected even when SSDs move at a high speed and even when they are overturned and tilted, and the possibility of data loss can be minimized in the event of collision and vibration; SSDs have an absolute advantage over the traditional hard disk in terms of shock resistance and impact resistance.

Low power consumption: the power consumption of SSDs is lower than that of traditional hard disks, and due to the use of flash memory chips without mechanical components, SSDs also have the characteristics of less heat generation and fast heat dissipation.

Noiseless: SSDs do not have mechanical motors and fans, thus a noise level thereof during operation is 0 dB, and flash-based SSDs typically have low energy consumption and heat generation in an operation state.

Large range of operating temperature: typical hard disk drives can only operate in a range of 5˜55° C., while most SSD can operate in a range of −10˜70° C.

Light weight: SSDs are smaller and lighter than a mechanical hard disk of the same capacity, and 20-30 grams lighter than a conventional 1.8 inch hard disk.

Firmware (FW) refers to programs written in EPROM (Erasable Programmable Read Only Memory) or EEPROM (Electrically Erasable Programmable Read-Only Memory), and also refers to the device “driver” stored in the device. The operating system relies on firmware (for example, firmware in the SSD) to drive a specific machine to operate according to a standard device driver. In order to make the SSD have comprehensive functions, the firmware needs to be upgraded.

Firmware version information mainly refers to a version number and version code of firmware, and is used for identifying the firmware version.

As an example, SSDs are usually connected with external devices capable of communicating, such as a host. Therefore, during the process of service interaction, the host requires the SSDs to upgrade firmware from time to time, which involves a switching between an old version of firmware and a new version of firmware. In order to ensure the online upgrading without interrupting service between the host and the SSD, a currently more mainstream method is to use transitional firmware to complete the firmware upgrade. In the upgrade process, it is required to ensure that hardware units inside the solid state disk still operate normally, and the internal message network is also required to be kept in a normal operation state. Therefore, this upgrade method leads to a higher difficulty and complexity in implementation, thus reducing the reliability of the upgrade.

In view of the above, one of the core creative points of the embodiments of the present disclosure is providing an online upgrading method for a solid state disk. The solid state disk includes at least an internal process interaction unit, as well as a CPU processing unit, a serial communication unit, a storage unit, a memory processing unit and a control peripheral unit that are respectively in communication connection with the internal process interaction unit. The solid state disk is in communication connection with a host via a serial communication unit. Firstly, in response to receiving a firmware upgrade instruction sent from the host, an interaction mode of the serial communication unit is set as a pause mode so as to ensure that no instruction sent from the host is received before the upgrade is completed. Next, the CPU processing unit is triggered to perform power-down processing, various units in the solid state disk are controlled to be switched to a standby state so as to ensure data consistency before and after the upgrade, and to ensure that no internal information interaction exists inside the solid state disk before the upgrade is completed. Next, a system reset operation is triggered for the solid state disk on the basis of the standby state, and firmware upgrade is performed on the solid state disk according to the firmware upgrade instruction. Finally, in response to the firmware upgrade being completed, initialization processing is performed on various units in the solid state disk, and the pause mode of the serial communication unit is canceled. Through the initialization processing of various units, the solid state disk is in a re-initialized state, it is not necessary to maintain the state before the upgrade, and it is not necessary to resume the information interaction before the upgrade. Therefore, the online upgrading can be completed in seconds without interrupting services, which greatly simplifies boundary processing of the new version of firmware, and improves the simplicity of firmware switching, upgrade efficiency and upgrade reliability.

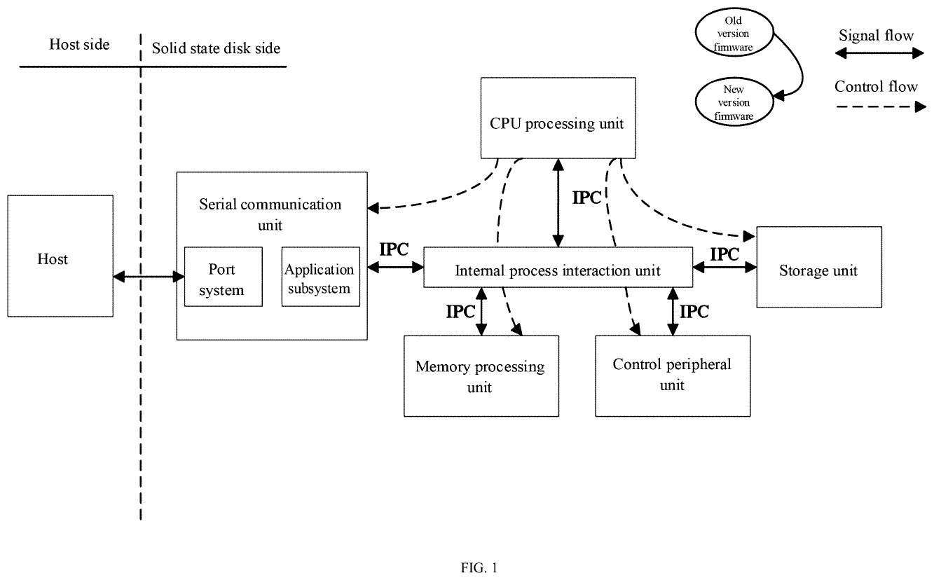

With reference to FIG. 1, FIG. 1 is a schematic diagram illustrating an internal structure of a solid state disk provided in an embodiment of the present disclosure. In order to better explain the upgrading process of the solid state disk, in addition to a solid state disk side, a host side is also shown in FIG. 1. It can be understood that the present disclosure is not limited thereto.

For the solid state disk side, the solid state disk may at least include an internal process interaction unit, as well as a CPU processing unit, a serial communication unit, a storage unit, a memory processing unit and a control peripheral unit that are respectively in communication connection with the internal process interaction unit. The solid state disk may be in communication connection with a host via a port system of the serial communication unit, and the serial communication unit may also include an application subsystem, so that the solid state disk may respond when an application is running. Furthermore, the other units in the solid state disk can be controlled by the CPU processing unit (such as a control flow direction indicated by a dotted line in FIG. 1), for example, controlling the initialization processing of the other units. The storage unit is configured to store data or interactive information about the units in the solid state disk. The memory processing unit is configured to process partial data in the solid state disk. The control peripheral unit refers to integrating specific functions of the solid state disk into one unit, and then a control port is provided to enable the processor to control. Units in the solid state disk can realize information interaction in the form of IPC (Inter-process communication) signal through the internal process interaction unit (the signal flow represented by solid lines as shown in FIG. 1).

In particular, the serial communication unit may be a PCIe (Peripheral Component Interconnect Express), and the internal process interaction unit may include an IPC internal information interaction network.

As a hardware unit interface interacting with a host, the PCIe may support the setting of a pause mode and a normal mode. The pause mode and the normal mode are two modes supported by the PCIe, and may be controlled and set via firmware. Under normal operating conditions, the interaction mode of the PCIe is the normal mode, and all the instructions from the host can be received in this case. When firmware upgrade is required, the interaction mode of the PCIe may be set as the pause mode after an upgrade instruction is received. Before the firmware upgrading is completed, no more instructions are obtained from the host, and only instructions inside the solid state disk are processed. When the firmware upgrading is completed, that is, when the firmware is switched from an old version to a new version, the interaction mode of the PCIe may be reset as the normal mode, such that the solid state disk can continue to receive and process instructions from the host.

For the IPC internal information interaction network, information is transferred and maintained via a Head (starting queue recording variable) and a Tail (ending queue recording variable) of a message cache queue, among them, the Head is used for recording a first position of the queue, and the Tail is used for recording a next position of a last position of the queue. For example, when unit A and unit B perform information interaction via the IPC internal information interaction network, the two together maintain the Head and the Tail of a message cache queue (a ring queue). When unit A sends information to unit B, unit A needs to maintain Tail information about the message cache queue, and the count of the Tail is incremented. When unit B processes information sent from unit A, the Head of the same message cache queue is maintained, namely, when information in the message cache queue is taken out, the count of the Head is incremented, that is to say, when unit A sends information to unit B, unit A maintains the Tail, and unit B maintains the Head, thereby achieving joint maintenance of the message cache queue by them.

It should be noted that the embodiments of the present disclosure include but are not limited to the above-mentioned examples, and it can be understood that those skilled in the art would have been able to make arrangements according to actual needs under the guidance of the idea of the embodiments of the present disclosure, which is not limited in the present disclosure.

In the embodiment of the present disclosure, an internal structural framework of a solid state disk is provided. The solid state disk includes at least an internal process interaction unit, as well as a CPU processing unit, a serial communication unit, a storage unit, a memory processing unit and a control peripheral unit that are respectively in communication connection with the internal process interaction unit. The solid state disk is in communication connection with a host via the serial communication unit. Firstly, in response to receiving a firmware upgrade instruction sent from the host, the interaction mode of the serial communication unit is set as the pause mode so as to ensure that no instruction sent from the host is received before the upgrade is completed. Then, the CPU processing unit is triggered to perform power-down processing, all units in the solid state disk are controlled to be switched to a standby state so as to ensure data consistency before and after the upgrade, and to ensure that there is no internal information interaction inside the solid state disk before the upgrade is completed. Then, a system reset operation is triggered for the solid state disk on the basis of the standby state, and firmware upgrade is performed on the solid state disk according to the firmware upgrade instruction. Finally, in response to the completion of the firmware upgrade, initialization processing is performed on each unit in the solid state disk, and the pause mode of the serial communication unit is canceled. Through the initialization processing of each unit, the solid state disk is in a re-initialized state, it is not necessary to maintain the state before the upgrade, and not necessary to resume the information interaction before the upgrade, so that the online upgrading can be completed in seconds without interrupting services. Therefore, boundary processing of the new version of firmware is greatly simplified, and the simplicity of firmware switching, upgrade efficiency and upgrade reliability are improved.

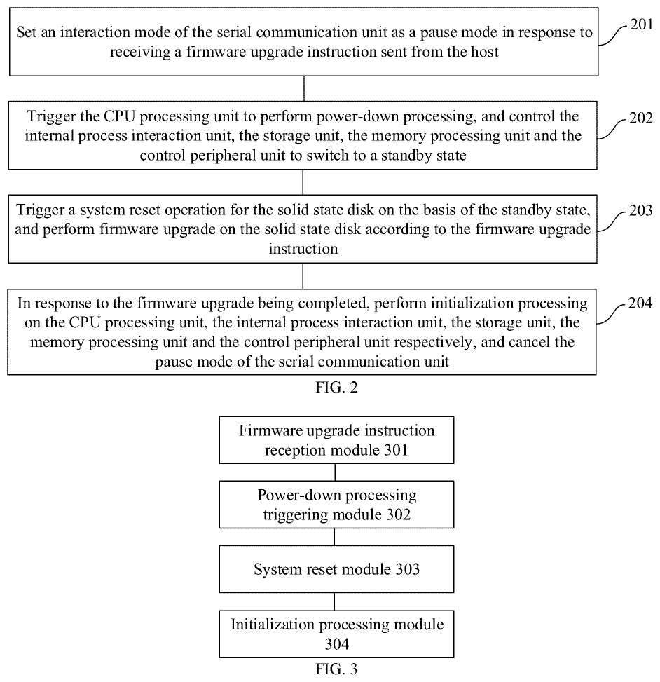

With reference to FIG. 2, FIG. 2 is a flow chart of an online upgrading method for a solid state disk provided in an embodiment of the present disclosure. The solid state disk at least includes an internal process interaction unit, as well as a CPU processing unit, a serial communication unit, a storage unit, a memory processing unit and a control peripheral unit that are respectively in communication connection with the internal process interaction unit. The solid state disk is in communication connection with a host via the serial communication unit. The method may include steps described below.

In step 201, an interaction mode of the serial communication unit is set as a pause mode in response to receiving a firmware upgrade instruction sent from the host.

In particular, in response to receiving the firmware upgrade instruction sent from the host, the interaction mode of the serial communication unit is set from the normal mode to the pause mode, which may be achieved by means of firmware, namely, by means of writing a hardware register. These two modes are set in the serial communication unit. After the interaction mode of the serial communication unit is set as the pause mode, the serial communication unit will not initiate an action of acquiring instructions from the host, and the solid state disk will not receive instructions from the host before the upgrade is completed.

In some embodiments of the present disclosure, the step, in which the interaction mode of the serial communication unit is set as the pause mode in response to receiving the firmware upgrade instruction sent from the host, may be: in response to receiving the firmware upgrade instruction sent from the host, switching the interaction mode of the serial communication unit from the normal mode to the pause mode according to a preset mode switching instruction, where the preset mode switching instruction may be set by firmware, i.e. by writing a hardware register.

Before the firmware upgrade is performed, valid data (such as running data processing data recorded, etc) of various units in the solid state disk may be stored first. Thus, before the interaction mode of the serial communication unit is set as the pause mode, valid data of the internal process interaction unit, valid data of the CPU processing unit, valid data of the serial communication unit, valid data of the memory processing unit and valid data of the control peripheral unit may be respectively stored in the storage unit, such that after the firmware upgrade is completed, it can be ensured that valid data in the solid state disk is not lost.

In some embodiments of the present disclosure, it is also possible to check whether the solid state disk is currently suitable for a firmware upgrade operation before the firmware upgrade is performed. Then, after the interaction mode of the serial communication unit is set as the pause mode and before the CPU processing unit is triggered to perform power-down processing, a timer in the CPU processing unit may be controlled to be initiated; and if it is not detected within a preset detection duration that the processing of the firmware upgrade instruction is completed, it is determined that there is an upgrade exception (the upgrade exception of the solid state disk includes but is not limited to the solid state disk being in a read-only operating mode or a temperature of the solid state disk is greater than or equal to a preset temperature threshold) in the solid state disk, the interaction mode of the serial communication unit is switched from the pause mode to the normal mode, and the firmware upgrade to the solid state disk is canceled. By checking in advance whether the solid state disk is currently suitable for the firmware upgrade, the firmware upgrade is avoided in the case where the solid state disk does not currently allow to perform the firmware upgrade.

After the interaction mode of the serial communication unit is switched from the pause mode to the normal mode, it is also possible to send upgrade exception information about the solid state disk to the host, and stop receiving a next firmware upgrade instruction sent from the host. On the one hand, it is possible to let a person using the host know that there is an exception condition currently existing in the solid state disk; on the other hand, it is possible to stop receiving and processing instructions sent from the host before the exception is solved.

In some embodiments of the present disclosure, if it is detected within a preset detection duration that the processing of the firmware upgrade instruction is completed, it can be determined that there is no upgrade exception currently in the solid state disk, and the CPU processing unit can be triggered to perform power-down processing, such that firmware upgrade is ensured to be performed under the condition that the solid state disk is suitable for firmware upgrade.

After the CPU processing unit is triggered to perform power-down processing, the timer in the CPU processing unit can also be controlled to be shut down, and the CPU processing unit is switched to the standby state so as to prepare for a subsequent firmware upgrade.

In step 202, the CPU processing unit is triggered to perform power-down processing, and the internal process interaction unit, the storage unit, the memory processing unit and the control peripheral unit are controlled to be switched to a standby state.

In a specific implementation, the CPU processing unit can be triggered to perform power-down processing, the serial communication unit is controlled to pause information interaction with the host, in response to the power-down processing being initiated in the CPU processing unit, the internal process interaction unit, the storage unit, the memory processing unit and the control peripheral unit are all controlled to be switched to the standby state. By switching various units to the standby state, it can ensure the consistency of the memory data in the solid state disk before and after the upgrade, and ensure that there is no internal information interaction inside the solid state disk before the upgrade is completed.

In some embodiments of the present disclosure, the internal process interaction unit may include an internal information interaction network that is used by various hardware units inside the solid state disk to perform information interaction. In this case, the step, in which the CPU processing unit is triggered to perform power-down processing, and the serial communication unit is controlled to pause information interaction with the host, may be: triggering the CPU processing unit to perform power-down processing, controlling the serial communication unit to pause information interaction with the host while clearing the interaction information in the internal information interaction network. Moreover, before clearing the interaction information in the internal information interaction network, the interaction information in the internal information interaction network can also be stored in the storage unit, such that the interaction information can be saved before the interaction information of each unit in the solid state disk is cleared, so as to avoid data loss.

In some embodiments of the present disclosure, the internal process interaction unit includes an internal information interaction network, then the step, in which power-down processing is initiated by the CPU processing unit, and the internal process interaction unit, the storage unit, the memory processing unit and the control peripheral unit are all controlled to be switched to a standby state, may be: initiating a disabling operation for the storage unit, the memory processing unit and the control peripheral unit, switching the internal process interaction unit to the standby state, and pausing information interaction of the internal information interaction network, so that other actions having nothing to do with firmware upgrade in the solid state disk can be paused, preventing an exception from occurring during a subsequent reset operation, ensuring the consistency of memory data in the solid state disk before and after the upgrade, improving the reliability of the upgrade, and ensuring that no internal information interaction exists inside the solid state disk before the upgrade is completed.

In step 203, on the basis of the standby state, a system reset operation for the solid state disk is triggered, and firmware upgrade is performed on the solid state disk according to the firmware upgrade instruction.

After units in the solid state disk are switched to the standby state, the system reset operation for the solid state disk can be triggered, and firmware upgrade is performed on the solid state disk according to the firmware upgrade instruction, so as to complete the switching from an old version of firmware to a new version of firmware and realize the online upgrading of the solid state disk.

In some embodiments of the present disclosure, the firmware upgrade instruction may contain firmware version information, then firmware upgrade may be performed on the solid state disk by using the firmware version information.

In step 204, in response to the firmware upgrade being completed, initialization processing is performed on the CPU processing unit, the internal process interaction unit, the storage unit, the memory processing unit and the control peripheral unit respectively, and the pause mode of the serial communication unit is canceled.

After the online firmware upgrade of the solid state disk is completed, initialization processing can be performed on units in the solid state disk, and the pause mode of the serial communication unit is canceled, so as to restore the normal interaction mode between the host and the solid state disk. In response to the completion of the firmware upgrade, initialization processing can be performed on the CPU processing unit, the internal process interaction unit, the storage unit, the memory processing unit and the control peripheral unit, respectively, and the pause mode of the serial communication unit is canceled, so that the solid state disk is in a re-initialized state through the initialization processing on each unit. It is not necessary to maintain the state before the upgrade and to resume the information interaction before the upgrade, thus the online upgrading can be completed in seconds without interrupting services, which greatly simplifies the boundary processing of the new version of firmware and improves the simplicity of firmware switching and upgrade efficiency.

In some embodiments of the present disclosure, message cache queues of hardware units in the solid state disk may be stored in the internal process interaction unit. Then, the initialization processing may be respectively performed on the CPU processing unit, the internal process interaction unit, the storage unit, the memory processing unit and the control peripheral unit by: performing initialization processing on a message cache queue of the CPU processing unit, a message cache queue of the internal process interaction unit, a message cache queue of the storage unit, a message cache queue of the memory processing unit and a message cache queue of the control peripheral unit, respectively.

In some embodiments of the present disclosure, the message cache queue may at least include a starting queue recording variable Head and an ending queue recording variable Tail. Then, the message cache queue of the CPU processing unit, the message cache queue of the internal process interaction unit, the message cache queue of the storage unit, the message cache queue of the memory processing unit and the message cache queue of the control peripheral unit are initialized respectively by: performing initialization processing on the starting queue recording variable Head and the ending queue recording variable Tail of each message cache queue respectively. By performing initialization processing on the message cache queues of various units, the solid state disk can be in a re-initialized state, it is not necessary to maintain the state before the upgrade and to resume the information interaction of the message cache queue before the upgrade. Therefore, the online upgrading can be completed in seconds without interrupting services, which greatly simplifies the boundary processing of the new version of firmware, and improves the simplicity of firmware switching and upgrade efficiency.

In some embodiments of the present disclosure, the pause mode of the serial communication unit is canceled by: switching the interaction mode of the serial communication unit from the pause mode to the normal mode. After the pause mode of the serial communication unit is canceled, the firmware upgrade result may also be returned to the host such that a person using the host can know the firmware upgrade result in a timely manner.

It should be noted that the embodiments of the present disclosure include but are not limited to the above-mentioned examples, and it can be understood that those skilled in the art would have been able to make arrangements according to actual needs under the guidance of the idea of the embodiments of the present disclosure, which is not limited in the present disclosure.

In the embodiment of the present disclosure, an online upgrading method for a solid state disk is provided, where the solid state disk includes at least an internal process interaction unit, as well as a CPU processing unit, a serial communication unit, a storage unit, a memory processing unit and a control peripheral unit that are respectively in communication connection with the internal process interaction unit. The solid state disk is in communication connection with a host via the serial communication unit. Firstly, in response to receiving a firmware upgrade instruction sent from the host, an interaction mode of the serial communication unit is set as a pause mode so as to ensure that no instruction sent from the host is received before the upgrade is completed. Next, the CPU processing unit is triggered to perform power-down processing, each unit in the solid state disk is controlled to be switched to a standby state so as to ensure data consistency before and after the upgrade, and to ensure that no internal information interaction exists in the solid state disk before the upgrade is completed. Next, a system reset operation is triggered for the solid state disk on the basis of the standby state, and firmware upgrade is performed on the solid state disk according to the firmware upgrade instruction. Finally, in response to the firmware upgrade being completed, initialization processing is performed on units in the solid state disk, and the pause mode of the serial communication unit is canceled. Through the initialization processing of various units, the solid state disk is in a re-initialized state, it is not necessary to maintain the state before the upgrade, and to resume the information interaction before the upgrade. Therefore, the online service upgrade can be completed in seconds without interrupting services, which greatly simplifies boundary processing of the new version of firmware, and improves the simplicity of firmware switching, upgrade efficiency and upgrade reliability.

It should be noted that for simplicity of explanation, method embodiments are presented as a series of combinations of acts, but those skilled in the art will recognize that the embodiments of the present disclosure are not limited by the order of acts described, as some steps may occur in other orders or concurrently according to the embodiments of the present disclosure. Secondly, those skilled in the art would also know that the embodiments described in the description are all preferred embodiments, and the actions involved are not necessarily required by the embodiments of the present disclosure.

With reference to FIG. 3, FIG. 3 is a structural block diagram of an online upgrading apparatus for a solid state disk provided in an embodiment of the present disclosure. The solid state disk at least includes an internal process interaction unit, as well as a CPU processing unit, a serial communication unit, a storage unit, a memory processing unit and a control peripheral unit that are respectively in communication connection with the internal process interaction unit. The solid state disk is in communication connection with a host via the serial communication unit. The apparatus may include a firmware upgrade instruction reception module 301, a power-down processing triggering module 302, a system reset module 303 and an initialization processing module 304.

The firmware upgrade instruction reception module 301 is configured for setting an interaction mode of the serial communication unit as a pause mode in response to receiving a firmware upgrade instruction sent from the host.

The power-down processing triggering module 302 is configured for triggering the CPU processing unit to perform power-down processing, and controlling the internal process interaction unit, the storage unit, the memory processing unit and the control peripheral unit to switch to a standby state.

The system reset module 303 is configured for triggering a system reset operation for the solid state disk on the basis of the standby state, and performing firmware upgrade on the solid state disk according to the firmware upgrade instruction.

The initialization processing module 304 is configured for, in response to the firmware upgrade being completed, performing initialization processing on the CPU processing unit, the internal process interaction unit, the storage unit, the memory processing unit and the control peripheral unit respectively, and canceling the pause mode of the serial communication unit.

In some embodiments of the present disclosure, the firmware upgrade instruction reception module 301 is configured for:
in response to receiving the firmware upgrade instruction sent from the host, switching the interaction mode of the serial communication unit from a normal mode to the pause mode according to a preset mode switching instruction.

In some embodiments of the present disclosure, the apparatus further includes:
a valid data storage module configured for storing valid data of the internal process interaction unit, valid data of the CPU processing unit, valid data of the serial communication unit, valid data of the memory processing unit and valid data of the control peripheral unit in the storage unit respectively.

In some embodiments of the present disclosure, the power-down processing triggering module 302 is configured for:
triggering the CPU processing unit to perform power-down processing, and controlling the serial communication unit to pause information interaction with the host.

In some embodiments of the present disclosure, the internal process interaction unit includes an internal information interaction network that is used by hardware units inside the solid state disk to perform information interaction. The power-down processing triggering module 302 is configured for:
triggering the CPU processing unit to perform power-down processing, and controlling the serial communication unit to pause information interaction with the host while clearing interaction information in the internal information interaction network.

In some embodiments of the present disclosure, the apparatus further includes:
an interaction information storage module configured for storing the interaction information in the internal information interaction network to the storage unit.

In some embodiments of the present disclosure, the apparatus further includes:
a timer controlling and activating module, configured for controlling to a timer in the CPU processing unit to be activated, and if it is not detected within a preset detection duration that processing of the firmware upgrade instruction is completed, determining that an upgrade exception exits in the solid state disk, switching the interaction mode of the serial communication unit to a normal mode from the pause mode, and canceling the firmware upgrade on the solid state disk.

In some embodiments of the present disclosure, the apparatus further includes:
a power-down processing triggering submodule configured for triggering the CPU processing unit to perform power-down processing if it is detected within a preset detection duration that the processing of the firmware upgrade instruction is completed.

In some embodiments of the present disclosure, the apparatus further includes:
a timer control shutdown module configured for controlling to control the timer in the CPU processing unit to be shut down, and switching the CPU processing unit to the standby state.

In some embodiments of the present disclosure, the internal process interaction unit includes an internal information interaction network, and the power-down processing triggering module 302 is used for:
initiating a disabling operation for the storage unit, the memory processing unit and the control peripheral unit, switching the internal process interaction unit to the standby state, and pausing the information interaction of the internal information interaction network.

In some embodiments of the present disclosure, the apparatus includes:
an upgrade exception information transmission module configured for transmitting upgrade exception information about the solid state disk to the host, and stopping receiving next firmware upgrade instruction sent from the host.

In some embodiments of the present disclosure, the upgrade exception of the solid state disk includes that the solid state disk is in a read-only operating mode, or that a temperature of the solid state disk is greater than or equal to a preset temperature threshold.

In some embodiments of the present disclosure, message cache queues of hardware units in the solid state disk are stored in the internal process interaction unit, and the initialization processing module 304 includes:
a message cache queue initialization module configured for performing initialization processing on a message cache queue of the CPU processing unit, a message cache queue of the internal process interaction unit, a message cache queue of the storage unit, a message cache queue of the memory processing unit and a message cache queue of the control peripheral unit respectively.

In some embodiments of the present disclosure, the message cache queue at least includes a starting queue recording variable Head and an ending queue recording variable Tail, and the message cache queue initialization module is configured for:
performing initialization processing on the starting queue recording variable Head and the ending queue recording variable Tail of each message cache queue.

In some embodiments of the present disclosure, the initialization processing module 304 includes:
an interaction mode switching module configured for switching the interaction mode of the serial communication unit from the pause mode to a normal mode.

In some embodiments of the present disclosure, the system reset module 303 includes:
a firmware upgrade module configured for performing firmware upgrade on the solid state disk using the firmware version information.

In some embodiments of the present disclosure, the apparatus further includes:
a firmware upgrade result returning module configured for returning a firmware upgrade result to the host.

The apparatus embodiments are substantially similar to the method embodiments, thus the description thereof is relatively simple, reference may be made to related parts of the description of the method embodiments.

In addition, an embodiment of the present application also provides an electronic device, including: a processor, a memory, and a computer program stored on the memory and executable on the processor. When the computer program is executed by the processor, it implements the various processes of the online upgrading method for a solid state disk described above, and can achieve the same technical effect. To avoid repetition, it will not be repeated here.

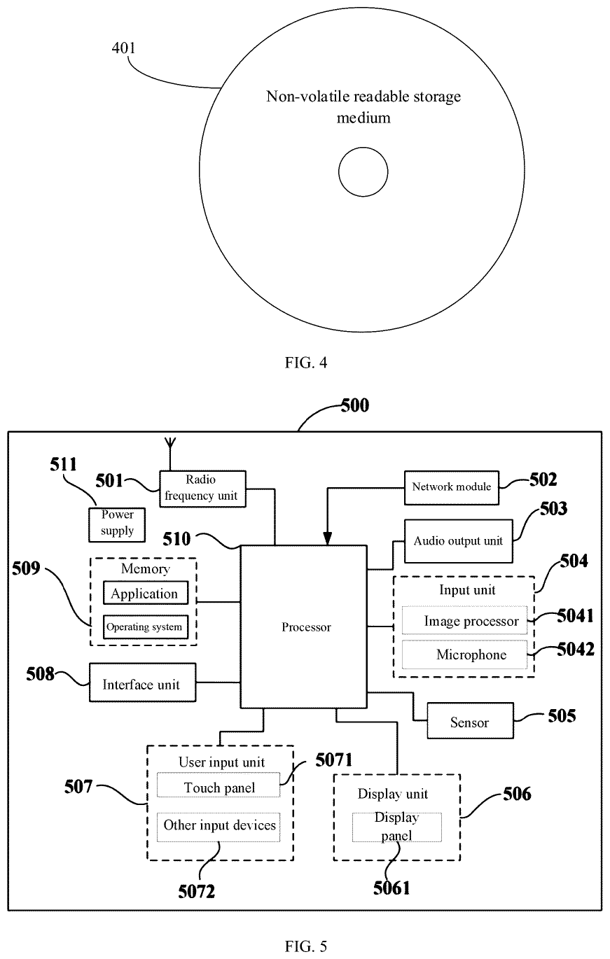

As shown in FIG. 4, the present disclosure further discloses a non-transitory readable storage medium 401 stored with a computer program that, when executed by a processor, implements the various processes of the above-mentioned embodiment of the online upgrading method for a solid state disk, and can achieve the same technical effect, and in order to avoid repetition, the description thereof will not be repeated. The non-transitory readable storage medium 401 may be, for example, a read-only memory (ROM), a random access memory (RAM), a magnetic disk or an optical disk.

FIG. 5 is a schematic diagram of a hardware structure of an electronic device for implementing various embodiments of the present application.

The electronic device 500 includes, but is not limited to: a radio frequency unit 501, a network module 502, an audio output unit 503, an input unit 504, a sensor 505, a display unit 506, a user input unit 507, an interface unit 508, a memory 509, a processor 510, and a power supply 511, etc. Those skilled in the art can understand that the electronic device structure involved in the embodiments of the present disclosure does not constitute a limitation on the electronic device. The electronic device may include more or fewer components than shown in the figure, or combine certain components, or arrange different components. In an embodiment of the present disclosure, the electronic device includes, but is not limited to, a cell phone, a tablet computer, a notebook computer, a palmtop computer, a vehicle-mounted terminal, a wearable device, a pedometer, etc.

It should be understood that in the embodiments of the present disclosure, the radio frequency unit 501 can be configured for receiving and transmitting signals during messaging or calling. The radio frequency unit 501 is configured for receiving downlink data from a base station and transmitting the same to the processor 510 for processing: and transmitting uplink data the base station. Generally, the radio frequency unit 501 includes, but is not limited to, an antenna, at least one amplifier, a transceiver, a coupler, a low noise amplifier, a duplexer, etc. In addition, the radio frequency unit 501 may also communicate with networks and other devices through a wireless communication system.

The electronic device uses the network module 502 to provide the user with wireless broadband Internet access, such as facilitating the user to send and receive e-mail, browse web pages, and access streaming media.

The audio output unit 503 may convert the audio data received by the radio frequency unit 501 or the network module 502 or stored in the memory 509 into an audio signal and output as sound. Moreover, the audio output unit 503 may also provide audio output (e.g. calling signal reception sound, message reception sound, etc.) related to a particular function performed by the electronic device 500. The audio output unit 503 includes a speaker, a buzzer, and a receiver, etc.

The input unit 504 is configured for receiving an audio or video signal. The input unit 504 may include a graphics processing unit (GPU) 5041 and a microphone 5042. The GPU processes image data of a still picture or video captured by an image capturing apparatus such as a camera in a video capturing mode or an image capturing mode. The processed image frame may be displayed on the display unit 506. Image frames processed by the graphics processing unit 5041 may be stored in memory 509 (or other storage medium) or transmitted via radio frequency unit 501 or network module 502. The microphone 5042 can receive sound and can process such sound into audio data. The processed audio data can be converted into a format output that can be transmitted to the mobile communication base station via the radio frequency unit 501 in case of a telephone call mode.

The electronic device 500 also includes at least one sensor 505, such as a light sensor, a motion sensor, and other sensors. The light sensor includes an ambient light sensor that can adjust a brightness of the display panel 5061 according to a brightness of ambient light and a proximity sensor that can turn off the display panel 5061 and/or backlight when the electronic device 500 moves to the ear. As one type of motion sensor, an accelerometer sensor can detect a magnitude of acceleration in various directions (generally three axes), and can detect a magnitude and a direction of gravity at rest, and can be used for identifying a posture of the electronic device (such as horizontal and vertical screen switching, relevant games and magnetometer posture calibration) and relevant functions about identification of vibration (such as pedometer and knocking), etc. The sensor 505 may further include a fingerprint sensor, a pressure sensor, an iris sensor, a molecular sensor, a gyroscope, a barometer, a hygrometer, a thermometer, an infrared sensor, etc. which will not be described in detail herein.

The display unit 506 is configured for displaying information input by the user or information provided to the user. The display unit 506 may include a display panel 5061, which may be configured in the form of a liquid crystal display (LCD), an organic light-emitting diode (OLED), or the like.

The user input unit 507 may be used to receive input numeric or character information and to generate key signal inputs related to user settings and function controls of the electronic device. The user input unit 507 includes a touch panel 5071 and other input devices 5072. The touch panel 5071, also referred to as a touch screen, may collect user touch operations on or near it (e.g. operations on or near the touch panel 5071 using any suitable object or accessory, such as a finger, stylus, etc., by the user). The touch panel 5071 may include two parts, a touch detection apparatus and a touch controller. The touch detection apparatus detects a touch orientation of a user, detects a signal brought by a touch operation, and transmits the signal to the touch controller; the touch controller receives touch information from the touch detection apparatus, converts it into contact point coordinates, and sends same to the processor 510, and receives and executes commands sent by the processor 510. In addition, the touch panel 5071 may be implemented using various types of resistive type, capacitive type, infrared type, and surface acoustic wave type. In addition to the touch panel 5071, the user input unit 507 may also include other input devices 5072. In particular, other input devices 5072 may include, but are not limited to, a physical keyboard, a function key (such as a volume control key, a switch key, etc.), a trackball, a mouse, a joystick, etc. which will not be described in detail herein.

Further, the touch panel 5071 can be overlaid on the display panel 5061, and when the touch panel 5071 detects a touch operation thereon or thereabout, the touch operation is transmitted to the processor 510 to determine a type of a touch event, and then the processor 510 provides a corresponding visual output on the display panel 5061 according to the type of the touch event. It will be appreciated that in one embodiment, the touch panel 5071 and the display panel 5061 are implemented as two separate components to implement the input and output functions of the electronic device, but in some embodiments, the touch panel 5071 may be integrated with the display panel 5061 to implement the input and output functions of the electronic device, which is not limited herein.

The interface unit 508 is an interface for connecting an external apparatus with the electronic device 500. For example, the external apparatus may include a wired or wireless headset port, an external power supply (or battery charger) port, a wired or wireless data port, a memory card port, a port for connecting to an apparatus having an identification module, an audio input/output (I/O) port, a video I/O port, an earphone port, etc. The interface unit 508 may be used to receive input (e.g. data information, power, etc.) from an external apparatus and transmit the received input to one or more elements within the electronic device 500 or may be used to transmit data between the electronic device 500 and an external apparatus.

The memory 509 can be used to store software programs and various data. The memory 509 may mainly include a storage program area and a storage data area, wherein the storage program area may store an operating system, at least one application required for a function (such as sound playback function, image playback function, etc.); and the storage data area can store data created on the basis of the use of the mobile phone (such as audio data, phone book etc.), etc. In addition, the memory 509 may include high speed random access memory and may also include non-transitory memory, such as at least one magnetic disk storage device, flash memory device, or other volatile solid state storage devices.

The processor 510 is a control center of the electronic device, connecting various parts of the entire electronic device through various interfaces and circuits. By running or executing software programs and/or modules stored in memory 509, as well as calling data stored in memory 509, functions of the electronic device are performed and data is processed, thereby monitoring the electronic device as a whole. The processor 510 may include one or more processing units; preferably, the processor 510 may integrate an application processor, which primarily processes operating systems, user interfaces, applications, etc. and a modem processor, which primarily processes wireless communications. It will be appreciated that the modem processor described above may not be integrated into the processor 510.

The electronic device 500 may also include a power supply 511 (such as a battery) that supplies power to various components. Preferably, the power supply 511 can be logically connected to the processor 510 through a power supply management system, thereby achieving functions such as managing charging, discharging, and power consumption through the power supply management system.

In addition, the electronic device 500 includes some functional modules, which are not shown, and will not be described in detail herein.

It should be noted that the terms “including”, “comprising” or any other variations thereof used herein are intended to encompass non-exclusive inclusion, thereby making the process, method, item, or device that includes a series of elements not only include those elements but also include other elements that are not explicitly listed, or also include elements inherent to such a process, method, item, or device. Unless further restricted, the elements limited by the phrase “including a . . . ” do not exclude the existence of additional identical elements in the process, method, item, or device that includes such an element.

Through the description of the implementation methods above, those skilled in art can clearly understand that the aforementioned exemplary methods can be implemented using software plus the necessary general hardware platforms, and of course, they can also be implemented through hardware, but in many cases, the former is a better way of implementation. Based on this understanding, the technical solution of this application, or the part that contributes to the existing technology, can essentially or be embodied in the form of a software product, which is stored in a storage medium (such as ROM/RAM, disk, CD), including several instructions to enable a terminal (which can be a mobile phone, computer, server, air conditioner, or network device, etc.) to perform the methods described in the various embodiments of this application.

The embodiments of the present disclosure are described above in conjunction with the accompanying drawings, but the application is not limited to the specific implementations described above. The specific implementations described above are merely illustrative and not restrictive. Those skilled in the art, under the inspiration of the present disclosure, can make many forms without departing from the purpose and scope of protection of the claims of this application, which all belong to the protection within the present disclosure.

Those skilled in the art can realize that, in combination with the units and algorithm steps of each example described in the embodiments disclosed in the present application, they can be implemented by electronic hardware or a combination of computer software and electronic hardware. Whether these functions are executed in hardware or software depends on the specific application and design constraints of the technical solution. Professional technicians can use different methods to implement the described functions for each specific application, but this implementation should not be considered to exceed the scope of the present application.

Those skilled in the art can clearly understand that for the convenience and brevity of description, the specific working processes of the systems, devices and units described above can refer to the corresponding processes in the above method embodiments and will not be repeated here.

In the embodiments provided by the present disclosure, it should be understood that the disclosed devices and methods can be implemented in other ways. For example, the device embodiments described above are only illustrative. For example, the division of units is only a logical function division. In actual implementation, there can be other division methods. For example, multiple units or components can be combined or integrated into another system, or some features can be ignored or not executed. The coupling or direct coupling or communication connection between the displayed or discussed can be through some interfaces, and the indirect coupling or communication connection of devices or units can be in electrical, mechanical or other forms.

The unit described as a separate component may or may not be physically separated. The component displayed as a unit may or may not be a physical unit, that is, it can be located in one place or distributed on multiple network units. Some or all of the units can be selected according to actual needs to achieve the purpose of this embodiment.

In addition, in each embodiment of the present disclosure, the functional units can be integrated into one processing unit, or each unit can exist physically separately, or two or more units can be integrated into one unit.

If the function is implemented in the form of a software functional unit and sold or used as an independent product, it can be stored in a readable storage medium. Based on this understanding, the technical solution of the present disclosure essentially or the part that contributes to the existing technology or part of the technical solution can be embodied in the form of a software product. The computer software product is stored in a storage medium and includes several instructions to enable a computer device (which can be a personal computer, server, or network device, etc.) to execute all or part of the steps of the methods described in various embodiments of the present application. The aforementioned storage media include: various media that can store program codes such as USB flash drives, mobile hard disks, ROM, RAM, magnetic disks or optical disks.

In addition, the embodiments of the present disclosure may involve the use of user data. In practical applications, user-specific personal data can be used in the solutions described herein within the scope permitted by applicable laws and regulations (for example, with the user's explicit consent, effective notification to the user, etc.) and in accordance with the applicable laws and regulations requirements of the country where it is located.

The above is only the specific implementation method of the present disclosure, but the protection scope of the present disclosure is not limited thereto. Any technician familiar with the technical field of the present disclosure can easily think of changes or replacements within the technical scope disclosed by the present disclosure, and all these changes or replacements should be covered within the protection scope of the present disclosure. Therefore, the protection scope of the present disclosure should be subject to the protection scope of the claims.

1. An online upgrading method for a solid state disk, wherein the solid state disk at least comprises an internal process interaction unit, as well as a CPU processing unit, a serial communication unit, a storage unit, a memory processing unit and a control peripheral unit that are respectively in communication connection with the internal process interaction unit, wherein the solid state disk is in communication connection with a host via the serial communication unit, the method comprising:
setting an interaction mode of the serial communication unit as a pause mode in response to receiving a firmware upgrade instruction sent from the host;
triggering the CPU processing unit to perform power-down processing, and controlling the internal process interaction unit, the storage unit, the memory processing unit and the control peripheral unit to switch to a standby state;
triggering a system reset operation for the solid state disk on the basis of the standby state, and performing firmware upgrade on the solid state disk according to the firmware upgrade instruction; and
in response to the firmware upgrade being completed, performing initialization processing on the CPU processing unit, the internal process interaction unit, the storage unit, the memory processing unit and the control peripheral unit respectively, and canceling the pause mode of the serial communication unit.

2. The method according to claim 1, wherein the setting an interaction mode of the serial communication unit as a pause mode in response to receiving a firmware upgrade instruction sent from the host comprises:
in response to receiving the firmware upgrade instruction sent from the host, switching the interaction mode of the serial communication unit from a normal mode to the pause mode according to a preset mode switching instruction;
wherein the preset mode switching instruction is set by writing a hardware register.

3. The method according to claim 1, wherein before setting the interaction mode of the serial communication unit as the pause mode, the method further comprises:
storing valid data of the internal process interaction unit, valid data of the CPU processing unit, valid data of the serial communication unit, valid data of the memory processing unit and valid data of the control peripheral unit in the storage unit respectively.

4. The method according to claim 1, wherein the triggering the CPU processing unit to perform power-down processing comprises:
triggering the CPU processing unit to perform power-down processing and controlling the serial communication unit to pause information interaction with the host.

5. The method according to claim 4, wherein the internal process interaction unit comprises an internal information interaction network that is used by various hardware units inside the solid state disk to perform information interaction, the triggering the CPU processing unit to perform power-down processing and controlling the serial communication unit to pause information interaction with the host comprises:
triggering the CPU processing unit to perform power-down processing, and controlling the serial communication unit to pause information interaction with the host while clearing interaction information in the internal information interaction network.

6. The method according to claim 5, wherein before clearing interaction information in the internal information interaction network, the method further comprises:
storing the interaction information in the internal information interaction network to the storage unit.

7. The method according to claim 1, wherein after setting the interaction mode of the serial communication unit as the pause mode, and before triggering the CPU processing unit to perform power-down processing, the method further comprises:
controlling a timer in the CPU processing unit to be activated, in response to having not detected within a preset detection duration that processing of the firmware upgrade instruction is completed, determining that an upgrade exception exists in the solid state disk, switching the interaction mode of the serial communication unit from the pause mode to a normal mode, and canceling the firmware upgrade on the solid state disk.

8. The method according to claim 7, further comprising:
in response to having detected within a preset detection duration that the processing of the firmware upgrade instruction is completed, triggering the CPU processing unit to perform power-down processing.

9. The method according to claim 8, wherein after the triggering the CPU processing unit to perform power-down processing, the method further comprises:
controlling the timer in the CPU processing unit to be shut down, and switching the CPU processing unit to the standby state.

10. The method according to claim 9, wherein the internal process interaction unit comprises an internal information interaction network, and the controlling the internal process interaction unit, the storage unit, the memory processing unit and the control peripheral unit to switch to the standby state comprises:
activating a disabling operation for the storage unit, the memory processing unit and the control peripheral unit, and switching the internal process interaction unit to the standby state, and pausing the information interaction of the internal information interaction network.

11. The method according to claim 7, wherein after the switching the interaction mode of the serial communication unit from the pause mode to the normal mode, the method comprises:
sending upgrade exception information about the solid state disk to the host, and stopping receiving a next firmware upgrade instruction sent from the host.

12. The method according to claim 7, wherein the upgrade exception of the solid state disk comprises that the solid state disk is in a read-only operating mode, or that a temperature of the solid state disk is greater than or equal to a preset temperature threshold.

13. The method according to claim 1, wherein message cache queues of various hardware units in the solid state disk are stored in the internal process interaction unit, and the performing initialization processing on the CPU processing unit, the internal process interaction unit, the storage unit, the memory processing unit and the control peripheral unit respectively comprises:
performing initialization processing on a message cache queue of the CPU processing unit, a message cache queue of the internal process interaction unit, a message cache queue of the storage unit, a message cache queue of the memory processing unit and a message cache queue of the control peripheral unit respectively.

14. The method according to claim 13, wherein each of the message cache queues at least comprises a starting queue recording variable Head and an ending queue recording variable Tail, and the performing initialization processing on the message cache queue of the CPU processing unit, the message cache queue of the internal process interaction unit, the message cache queue of the storage unit, the message cache queue of the memory processing unit and the message cache queue of the control peripheral unit respectively comprises:
performing initialization processing on the starting queue recording variable Head and the ending queue recording variable Tail of each of the message cache queues.

15. The method according to claim 1, wherein the canceling the pause mode of the serial communication unit comprises:
switching the interaction mode of the serial communication unit from the pause mode to a normal mode.

16. The method according to claim 1, wherein the firmware upgrade instruction contains firmware version information, and the performing firmware upgrade on the solid state disk according to the firmware upgrade instruction comprises:
performing firmware upgrade on the solid state disk using the firmware version information.

17. The method according to claim 1, wherein after canceling the pause mode of the serial communication unit, the method further comprises:
returning a firmware upgrade result to the host.

18. (canceled)

19. An electronic device, comprising a processor, a communication interface, a memory, and a communication bus, wherein the processor, the communication interface, and the memory communicate with each other via the communication bus;
the memory is configured for storing a computer program; and
the processor is configured for executing the program stored in the memory to implement the method according to claim 1.

20. A non-transitory readable storage medium storing instructions that, when executed by one or more processors, cause the one or more processors to perform the method according to claim 1.

21. The method according to claim 2, wherein before setting the interaction mode of the serial communication unit as the pause mode, the method further comprises:
storing valid data of the internal process interaction unit, valid data of the CPU processing unit, valid data of the serial communication unit, valid data of the memory processing unit and valid data of the control peripheral unit in the storage unit respectively.
